(19) United States
(12) Patent Application Publication
(10) Pub. No.: US 2018/0361993 A1
(43) Pub. Date: Dec. 20, 2018

(54) Biometric Lock System

(71) Applicant: Forrester J. Carroll, White Plains, NY (US)

(72) Inventor: Forrester J. Carroll, White Plains, NY (US)

(21) Appl. No.: 15/622,875

(22) Filed: Jun. 14, 2017

(51) Int. Cl. B60R 25/25; B60R 25/02

(52) U.S. Cl. CPC B60R 25/252; B60R 25/02; E05B 81/77

(57) ABSTRACT

A biometric lock system includes a vehicle that has a driver's side door. The driver's side door has a handle and a door lock and the vehicle has a steering wheel lock. A fingerprint unit is coupled to the vehicle and the fingerprint unit is positioned on the handle. In this way the fingerprint unit reads a fingerprint when the handle is gripped. The fingerprint unit is in electrical communication with the door lock and the steering wheel lock. Moreover, the fingerprint unit unlocks the door lock and the steering wheel lock when the fingerprint matches an authorized fingerprint. In this way the fingerprint unit inhibits the vehicle from being stolen.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to lock devices and more particularly pertains to a new lock device for inhibiting a vehicle from being stolen.

### BRIEF SUMMARY OF THE INVENTION

An embodiment of the disclosure meets the needs presented above by generally comprising a vehicle that has a driver's side door. The driver's side door has a handle and a door lock and the vehicle has a steering wheel lock. A fingerprint unit is coupled to the vehicle and the fingerprint unit is positioned on the handle. In this way the fingerprint unit reads a fingerprint when the handle is gripped. The fingerprint unit is in electrical communication with the door lock and the steering wheel lock. Moreover, the fingerprint unit unlocks the door lock and the steering wheel lock when the fingerprint matches an authorized fingerprint. In this way the fingerprint unit inhibits the vehicle from being stolen.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a phantom perspective view of a biometric lock system according to an embodiment of the disclosure.

FIG. 2 is a phantom view of a door handle of an embodiment of the disclosure.

FIG. 3 is a perspective interior view of vehicle of an embodiment of the disclosure.

FIG. 4 is a schematic view of an embodiment of the disclosure.

### DETAILED DESCRIPTION OF THE INVENTION

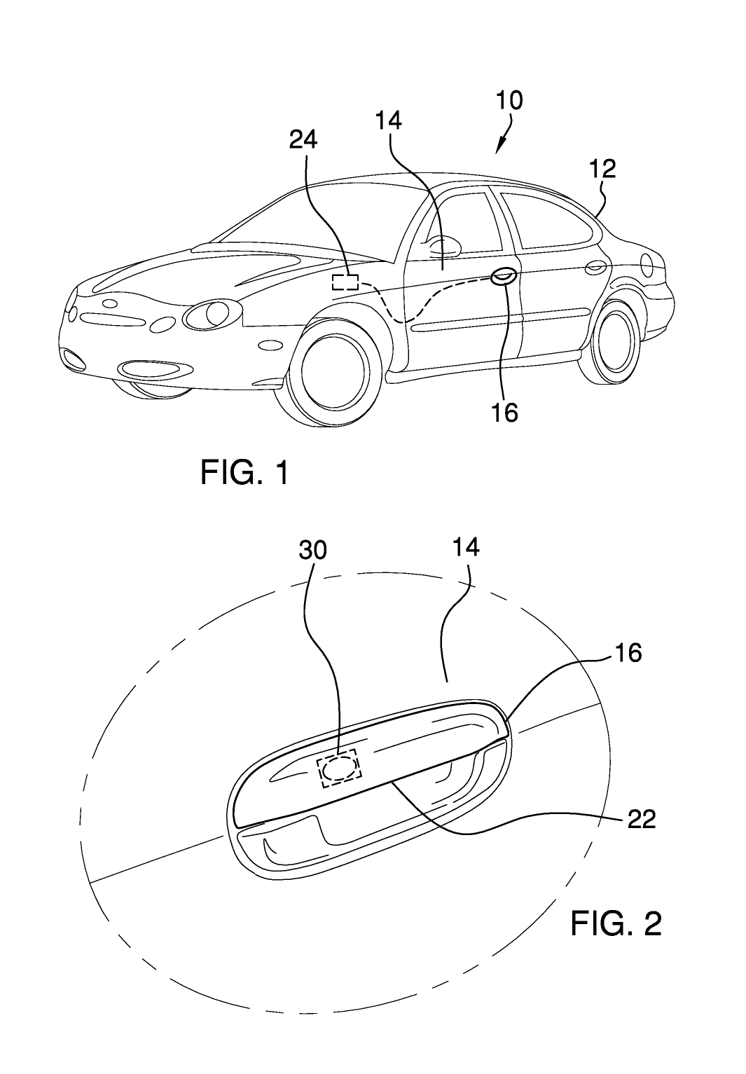

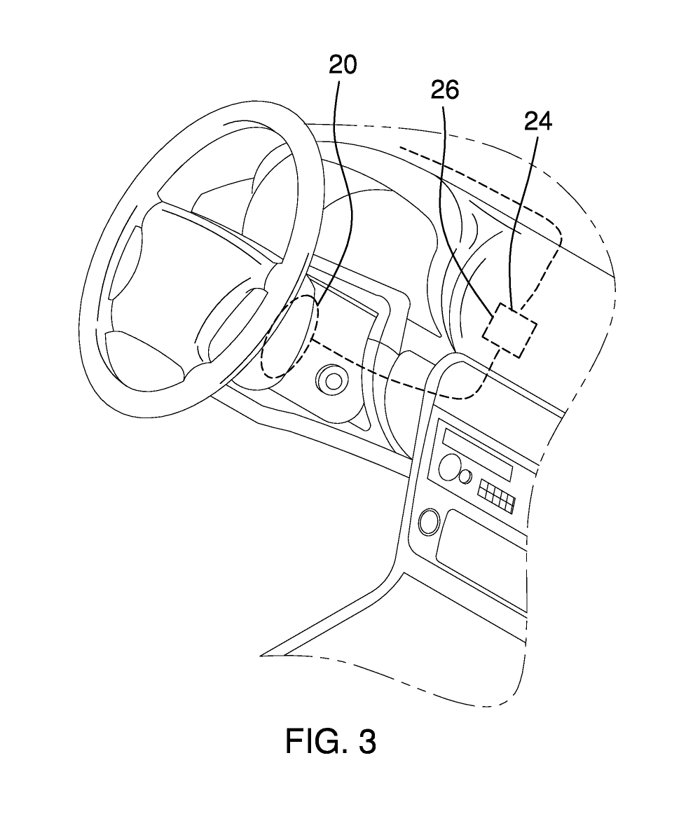

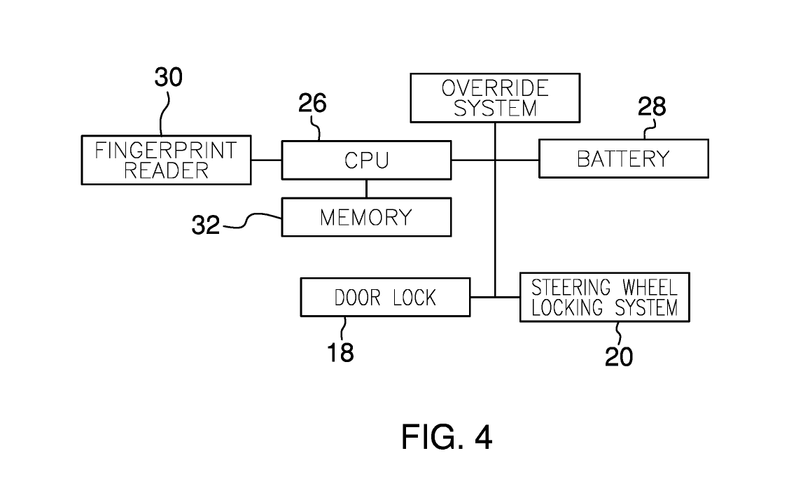

With reference now to the drawings, and in particular to FIGS. 1 through 4 thereof, a new lock device embodying the principles and concepts of an embodiment of the disclosure and generally designated by the reference numeral 10 will be described.

As best illustrated in FIGS. 1 through 4, the biometric lock system 10 generally comprises a vehicle 12 that has a driver's side door 14. The driver's side door 14 has a handle 16 and a door lock 18 and the vehicle 12 has a steering wheel lock 20. The vehicle 12 may be a passenger vehicle, a cargo vehicle and any other vehicle that can be driven. The handle 16 has a first surface 22 and the first surface 22 is spaced from the driver's side door 14.

A fingerprint unit 24 is coupled to the vehicle 12 and the fingerprint unit 24 is positioned on the handle 16. In this way the fingerprint unit 24 reads a fingerprint when the handle 16 is gripped and the fingerprint unit 24 is in electrical communication with the door lock 18 and the steering wheel lock 20. The fingerprint unit 24 unlocks the door lock 18 and the steering wheel lock 20 when the fingerprint matches an authorized fingerprint. In this way the fingerprint unit 24 inhibits the vehicle 12 from is stolen.

The fingerprint unit 24 comprises a processor 26 that is coupled to the vehicle 12. The processor 26 is electrically coupled to an electrical system 28 of the vehicle 12, the door lock 18 and the steering wheel lock 20. The processor 26 selectively generates an unlock sequence. Moreover, each of the door lock 18 and the steering wheel lock 20 is unlocked when the processor 26 generates the unlock sequence.

A fingerprint reader 30 is coupled to the first surface 22 of the handle 16 and the fingerprint reader 30 is touched by a finger when the handle 16 is gripped. In this way the fingerprint reader 30 may read a fingerprint on the finger when the handle 16 is gripped. The fingerprint reader 30 is electrically coupled to the processor 26 and the fingerprint reader 30 may be an electronic fingerprint reader 30 or the like.

An electronic memory 32 is coupled to the vehicle 12 and the electronic memory 32 is electrically coupled to the processor 26. The electronic memory 32 stores a fingerprint of an authorized user. Moreover, the processor 26 compares the fingerprint read when the handle 16 is gripped to the fingerprint of the authorized user. The processor 26 generates the unlock sequence when the fingerprint read when the handle 16 is gripped matches the fingerprint of the authorized user. In this way the driver's side door 14 and steering wheel are unlocked with the authorized user grips the handle 16 to open the driver's side door 14.

In use, the authorized user touches the fingerprint reader 30 to scan the authorized user's fingerprint into the electronic memory 32 during an initial set up of the fingerprint unit 24. The fingerprint reader 30 subsequently reads the fingerprint on the finger when the handle 16 on the driver's side door 14 is gripped. The processor 26 generates the unlock sequence when the fingerprint read when the handle 16 is gripped matches the fingerprint of the authorized user. Thus, the door lock 18 and the steering wheel lock 20 are unlocked thereby facilitating the vehicle 12 to be driven. The door lock 18 and the steering wheel lock 20 remain locked with the fingerprint read when the handle 16 is gripped does not match the fingerprint of the authorized user. In this way the fingerprint unit 24 inhibits the vehicle 12 from being stolen.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A biometric lock system comprising:
a vehicle having a driver's side door, said driver's side door having a handle and a door lock, said vehicle having a steering wheel lock; and
a fingerprint unit being coupled to said vehicle, said fingerprint unit being positioned on said handle wherein said fingerprint unit is configured to read a fingerprint when said handle is gripped, said fingerprint unit being in electrical communication with said door lock and said steering wheel lock, said fingerprint unit unlocking said door lock and said steering wheel lock when the fingerprint matches an authorized fingerprint wherein said fingerprint unit is configured to inhibit said vehicle from being stolen.

2. The system according to claim 1, wherein said fingerprint unit comprises a processor being coupled to said vehicle, said processor being electrically coupled to an electrical system of said vehicle, said processor being electrically coupled to said door lock and said steering wheel lock, said processor selectively generating an unlock sequence, each of said door lock and said steering wheel lock being unlocked when said processor generates said unlock sequence.

3. The system according to claim 2, wherein:
said handle has a first surface, said first surface being spaced from said driver's side door; and
a fingerprint reader being coupled to said first surface of said handle wherein said fingerprint reader is configured to be touched by a finger when said handle is gripped thereby facilitating said fingerprint reader to read a fingerprint on the finger, said fingerprint reader being electrically coupled to said processor.

4. The system according to claim 2, further comprising an electronic memory being coupled to said vehicle, said electronic memory being electrically coupled to said processor, said electronic memory storing a fingerprint of an authorized user, said processor comparing a fingerprint read when said handle is gripped to the fingerprint of the authorized user, said processor generating said unlock sequence when the fingerprint read when said handle is gripped matches the fingerprint of the authorized user.

5. A biometric lock system comprising:
a vehicle having a driver's side door, said driver's side door having a handle and a door lock, said vehicle having a steering wheel lock, said handle having a first surface, said first surface being spaced from said driver's side door; and
a fingerprint unit being coupled to said vehicle, said fingerprint unit being positioned on said handle wherein said fingerprint unit is configured to read a fingerprint when said handle is gripped, said fingerprint unit being in electrical communication with said door lock and said steering wheel lock, said fingerprint unit unlocking said door lock and said steering wheel lock when the fingerprint matches an authorized fingerprint wherein said fingerprint unit is configured to inhibit said vehicle from being stolen, said fingerprint unit comprising:
a processor being coupled to said vehicle, said processor being electrically coupled to an electrical system of said vehicle, said processor being electrically coupled to said door lock and said steering wheel lock, said processor selectively generating an unlock sequence, each of said door lock and said steering wheel lock being unlocked when said processor generates said unlock sequence,
a fingerprint reader being coupled to said first surface of said handle wherein said fingerprint reader is configured to be touched by a finger when said handle is gripped thereby facilitating said fingerprint reader to read a fingerprint on the finger, said fingerprint reader being electrically coupled to said processor, and
an electronic memory being coupled to said vehicle, said electronic memory being electrically coupled to said processor, said electronic memory storing a fingerprint of an authorized user, said processor comparing the fingerprint read when said handle is gripped to the fingerprint of the authorized user, said processor generating said unlock sequence when the fingerprint read when said handle is gripped matches the fingerprint of the authorized user.
